(19) United States
(12) Patent Application Publication
(10) Pub. No.: US 2019/0091654 A1
(43) Pub. Date: Mar. 28, 2019

(54) HIGHLY ABSORBENT AND ABSORBENT CAPILLARY HYDROPHOBIC POLYMER AND CORRESPONDING MANUFACTURING PROCESS

(71) Applicant: Vittorio CECCARINI, Pesaro (PU) (IT)

(72) Inventor: Vittorio CECCARINI, Pesaro (PU) (IT)

(21) Appl. No.: 16/094,679

(22) PCT Filed: Apr. 24, 2017
(86) PCT No.: PCT/IT2017/000086

§ 371 Date: Oct. 18, 2018

(30) Foreign Application Priority Data
Apr. 27, 2016 (IT) 102016000042911

(51) Int. Cl. B01J 20/26; C09K 3/32; B01J 20/30; B01J 20/28; C02F 1/28; C02F 1/68

(52) U.S. Cl. CPC B01J 20/262; C09K 3/32; B01J 20/3085; B01J 20/3007; C02F 2101/32; B01J 20/28033; C02F 1/285; C02F 1/681; B01J 20/28016

(57) ABSTRACT

The invention relates to an adsorbent and absorbent capillary hydrophobic polymer and to the related process for producing it; more particularly, this invention relates to a polymer derived from natural and synthetic oily substances, able to contain, remove and recover oil, hydrocarbons and chemical products of non-aqueous matrix in the event of spills or leaks of them inside or outside water.

### TECHNICAL FIELD

This invention relates to an adsorbent and absorbent capillary hydrophobic polymer and to the related process for its production. More particularly, this invention relates to a polymer derived from natural and synthetic oily substances, able to contain, remove and recover oil, hydrocarbons and chemical products of non-aqueous matrix in the event of spills or leaks of them inside or outside water.

The high fluidity of the polymer allows direct injection into moulds for making new manufactured products.

The product is environmentally-friendly because it is biodegradable and uses components with low toxicity as the expanding agent.

The hydrophobic capacity is guaranteed by the use of amorphous silica superficially treated with polyalkylsiloxane.

The composition of the product allows multiple cycles of product re-use and recovery of the oily substances spilled.

Manufactured products made using the above-mentioned polymer may be moulded and/or machined in various forms such as booms, pillows, carpets, floccules, powders, sheets, rolls, pellets, cords, bags, etc. in order to meet the different requirements in the event of industrial, commercial and domestic leaks.

### BACKGROUND ART

Despite technological progress, spills of oil, hydrocarbons, solvents and chemical products are still a serious problem that not only damages the environment by polluting oceans, ports, rivers, lakes and land, but also compromises the health of the affected population.

Leaks or spills may occur at all stages of industrial production of oil and of the above-mentioned products, also causing significant economic losses.

The statistics on oil spills from oil tankers show that between 1970 and 2014 more than 10,000 incidents were recorded, with 6,000,000 tons of oil leaked (see http://www.itopf.com/knowledge-resources/data-statistics/statistics).

The trend in the phenomenon relative to incidents involving oil tankers is falling, but other events such as earthquakes, tornadoes, floods, fires, human errors, war, terrorism and crime are definitely not, as we can all see almost daily in the national and international news. For this reason, improving the means for containing and eliminating the above-mentioned spills is an important and right and proper commitment.

There are many prior art solutions for absorbing, containing and removing oil spills.

There are prior art floating fabric belts for containing spills, used since the first incidents involving oil tankers: the pollutant is adsorbed and absorbed by the fabric which is then wrung out to recover oil and to allow re-use of the belt.

Actual possibilities for re-use of such devices are very limited, and depend on the density of the pollutant. Moreover, disposal of the belts causes further harm to the environment.

Traditional methods for absorbing and containing small spills using straw, sand, sawdust, vermiculite, etc. are well-known.

3M™ Oil & Petroleum Sorbents are products available on the market, designed for controlling and recovering oil and other oil-derived fluids, on land and in water. They repel and do not absorb water, whilst they absorb hydrocarbon-based liquids (as indicated on the website http://multimedia.3m.com/mws/media/413639O/3m-oil-petroleum-sorbent-product-information-sheet.pdf).

Said sorbents are made of polypropylene fibres (type T) and polypropylene mixed with polyester (type HP). However, said products have several disadvantages: it is not possible to use them on aqueous liquids or aggressive liquids, such as strong acids, caustic oxidizers or reactive chemical products. In particular, there is the risk of degradation with the following substances: oleum, chlorosulphonic acid, liquid bromine, fuming nitric acid, chromic acid, sulphuric acid and hydrogen peroxide. The product is disposed of by incineration.

There are also absorbent products available on the market, developed by the company Absorbent, Inc., made of 100% virgin cellulose fibre reclaimed from the pulp and paper production process, which act on liquid spills, absorbing them by capillarity and locking the waste in fibrous cores (as indicated on the website http://www.socksandpads.com/about us page.html). Those products are available in two separate lines: Absorbent GP for general use, in situations in which all types of liquids must be absorbed and removed; whilst Absorbent W absorbs hydro-carbons since it is water-repellent, and therefore is suitable for use in water.

Both of the above-mentioned products have two main disadvantages: they cannot be re-used and they only work on oily substances.

One method for separating hydrocarbons from liquids containing hydrocarbons is described in U.S. Pat. No. 6,841,077 B2 granted on 11 Jan. 2005.

A filtration media is presented, employing polymeric absorbents comprising a material selected from the group consisting of: styrene, pentadiene, cyclopentadiene, butylene, ethylene, isoprene, butadiene, propylene and mixtures thereof, and a filtration enabler intimately mixed with the absorbent polymer. Upon contact with a hydrocarbon containing liquid, said liquid partially dissolves the absorbent polymer forming a partial filtration barrier prior to the filtration media substantially absorbing the hydrocarbons, and allowing hydrocarbon-free liquid to flow through the filtration media. In situations of a leak or spill wherein an excess of hydrocarbons is present, the filtration media forms a plug to seal and prevent further discharge of the hydrocarbons. The filtration media may be placed inside a portable container for insertion into an existing drain such that hydrocarbon containing liquid is filtered through the device allowing hydrocarbon-free liquid to flow from the device.

A process for treating water for removal of oil and water-soluble petroleum oil components is described in European patent EP 0901805 published on 17 Mar. 1999 in the name of the company Amcol International Corporation.

That water treatment process involves removal of a majority of the water-insoluble petroleum oil components using an adsorbent, such as organophilic clay or an acid-activated smectite clay, such as acid-activated calcium bentonite clay, to provide a reduced-oil produced water in a first pretreatment step and then treating the reduced-oil produced water with a macroreticular adsorbent resin, such as styrene cross-linked with divinylbenzene, or a polyvinyl pyridine resin to remove marginally water-soluble petroleum oil components, such as C6+ carboxylic acids, phenolics, naphthenic carboxylic acid compounds and aromatic carboxylic acids, such as benzene carboxylic acids.

In fact, the prior art shows how it is still necessary to find and develop new, more effective solutions, in terms of technology and costs, designed to contain, remove and recover substances such as oil, hydrocarbons and chemical products of non-aqueous matrix in the event of spills or leaks of them inside or outside water.

In particular, the main problems of the existing products are listed below:
limited capacity for re-use;
limited range of safe applications;
biodegradability;
limited capacity for absorption and adsorption.

### DISCLOSURE OF THE INVENTION

The main aim of the invention is to overcome those disadvantages and to provide an invention with high and stable levels of hydrophobic performance, that can be re-used many times and that is rapidly biodegradable.

Accordingly, this invention achieves those aims with an adsorbent and absorbent capillary hydrophobic polymer derived from natural and synthetic oily substances, obtained by means of a specific preparation process.

According to the invention, the natural oily substances used include vegetable oils obtained from plant seeds and fruits of a wide range of species without any limitation, provided that they contain in their composition triglycerides and fatty acid with high molecular weight including OH groups.

According to the invention, the natural oily substances used are essential for maintaining the natural quality of the polymer, and for guaranteeing its rapid biodegradability.

The synthetic oily substance is a combination of MDI and TDI polymers.

The hydrophobic capacity of the polymer, described herein, is improved with the use of amorphous synthetic silica superficially treated with at least one type of siloxane.

The hydrophobic polymer according to the invention adsorbs and absorbs oil, hydrocarbons and chemical products of a non-aqueous matrix in the event of spills or leaks of them, inside or outside water.

The substances indicated above are absorbed in the cells of the polymer and adsorbed on its surface.

### BRIEF DESCRIPTION OF THE DRAWINGS

FIG. 1 shows the flow chart of the process for production of a highly adsorbent and absorbent capillary hydrophobic polymer C and a manufactured product D derived from it, where:
a1-a7, α1-α3, b1-b3 represent sub-components of the polymer (C), which are contained in tanks;
E25-E35, E42-E44 represent dosing devices for dosing the above-mentioned components;
E-17 represents a first container (or mixer);
E-20 represents a second container (or mixer);
E-24 represents a third container (or mixer);
E-36 represents a fourth container (or mixer);
E-14 represent an injection machine;
E-23 represents a compressed air system;
E-41 represents a mould;
A represents a first component of the polymer (C), derived from natural oily substances;
B represents a second component of the polymer (C), derived from synthetic oily substances, such as TDI and MDI polymers.

FIG. 2 illustrates two possible embodiments of manufactured products (D) constituted of the polymer (C): a “sausage”-shaped floating boom and a mat.

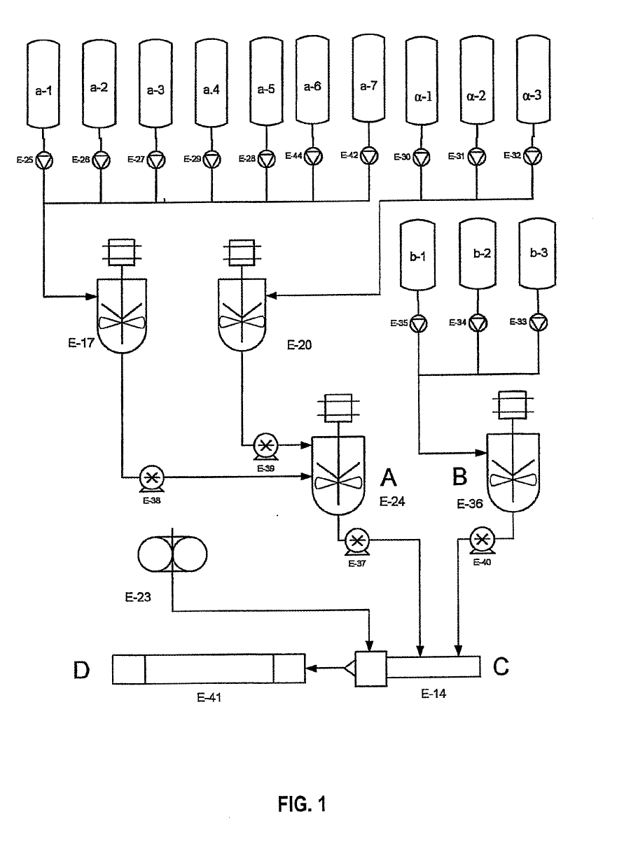

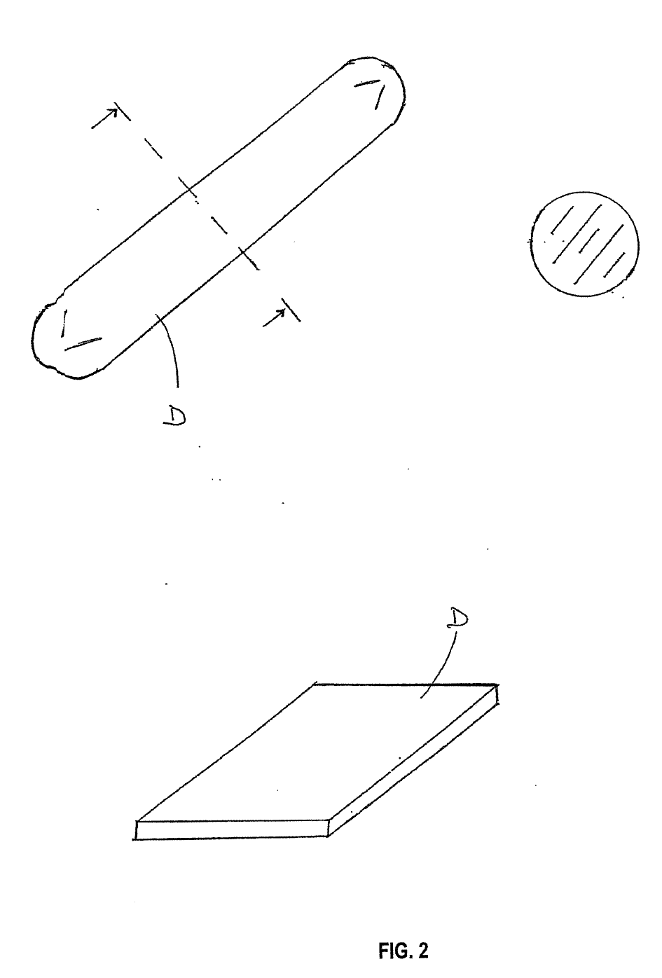

### DETAILED DESCRIPTION OF PREFERRED EMBODIMENT OF THE INVENTION

The adsorbent and absorbent capillary hydrophobic polymer (C) according to the invention comprises:
a first component (A) comprising polymers derived from natural oily substances such as plant seeds and fruits of a wide range of species without any limitation, provided that they contain in their composition triglycerides and fatty acids with high molecular weight containing OH groups. Non-limiting examples of such vegetable sources are: palms, coconuts, sunflower seeds, castor beans, linseed, pomegranate seeds, rapeseed. The hydrophobic agents are derived from amorphous silica superficially treated with polyalkylsiloxane;
a second component (B) comprising MDI polymers, derived from 4,4 diphenylmethane diisocyanate, 2,4 diphenylmethane diisocyanate, 2,2 diphenylmethane diisocyanate, with average functionality between 2.5 and 3 in combination with TDI 2,4 toluene diisocyanate.

The first component (A) is obtained from two agents (a-0, α-0), which are respectively obtained by mixing the sub-components (a-1-a-7, α-1-α-3).

In particular, the first agent (a-0) is obtained by mixing the first sub-components (a-1-a-7), with the following weight percentages:
70-90% vegetable oil (a-1) containing triglycerides and fatty acids;
2.0-5% de-ionized water (a-2);
0.1-1.5% low grade ethoxylation surfactant (a-3);
0.0-0.5% aminic catalyst and reaction accelerator (a-4);
0.2-1.5% metallic catalyst (a-5);
0.2-1.5% mass/volume stabilizer (a-6), like vegetable wax or paraffinic oil;
1.0-5% cream stabilizing agent (a-7) PDMS Polydimethylsiloxane.

The second agent (α-0) is obtained from a mix of second sub-components (α-1-α-3), with the following weight percentage of the different ingredients:
1.0-6.5% expanding agent (α-1);
2.0-6.0% chain extensor agent (α-2);
0.5-2.5% hydrophobic agent (α-3).

The second component (B) is obtained from a mix of third sub-components (b-1-b-3), with the following weight percentage of the different ingredients:
57-97% polymer MDI (b-1);
0.0-43% polymer TDI (b-2);
3.0-7.5% flow agent (b-3).

### Process for Obtaining the First Component (A)

In a first container (E17) rotating at 1350 (±20%) RPM, the sub-components (a-1), (a-2), (a-3), (a-4), (a-5), (a6) and (a7) are mixed for 20-30 minutes in order to obtain the first agent (a-0). According to the invention, the first container (E17) may also be a mixer.

In a second container (E20) rotating at 1400-1700 RPM, the sub-components (α1), (α-2), (α-3), are mixed for 10-15 minutes in order to obtain the second agent (α-0). According to the invention, the second container (E20) may also be a mixer.

In a third container (E-24), rotating at 1/4-1/3 RPM, the mentioned first agent and second agent (α-0,a-0) are mixed for 20-25 minutes in order to obtain the first component (A). According to the invention, the third container (E-24) may also be a mixer. It is also possible to put the content of the second container (E20) inside the first container (E17) and vice versa, lowering the rotation speed to 1/4-1/3 RPM.

### Process for Obtaining the Second Component (B)

In a fourth container (E-36), hermetically closed and isolated from the external atmosphere, rotating at 1/4-1/3 RPM, the sub-components (b1), (b-2) and (b-3) are mixed for 20-30 minutes in order to obtain the second component (B). According to the invention, the fourth container (E-36) may also be a mixer.

### Process for Obtaining the Capillary Hydrophobic Polymer (C) and the Manufactured Product (D)

Substantially equal quantities (47-53%) of the first component (A) and of the second component (B), obtained from the previous phases, are separately conveyed into the injection chamber of an injection machine (E-14) wherein the two components (A; B), in percentages of between 47% and 53%, are mixed by a flow of compressed air arriving from the compressed air system (E-23) for producing the polymer (C), which, through the exit nozzle of said injection chamber, feeds the mould connected to said nozzle, thereby starting the expansion process together with the forming process, in order to give the final commercial shape to the resulting manufactured product (D).

Within 20-120 minutes (depending on the volume of the mould), said manufactured product (D) solidifies, reaching the final mechanical properties, and is subsequently extracted from the mould so that it can be used as it is or mechanically machined to obtain other products such as sheets, powders, etc.

### Role of the Main Components

Component A is responsible for the formation of the adsorption and absorption cells and for guaranteeing biodegradability.

Component B acts on the conversion of the natural oily substances into polymers, giving the polymer (C) its mechanical properties.

The function of the second agent (α-0) is to improve the hydrophobic capabilities.

### Detailed List of Components of the Composition

vegetable oil (a-1) containing triglycerides and fatty acids with high molecular weight including OH groups; like 12-hydroxil-9 octadecenoic acid;
deionized water (a-2);
low grade (from 2 to 6 moles) ethoxylation surfactant (a-3), like nonylphenol ethoxylate, ethanol 2.2 dodecyloxy ethoxy and their mixture;
aminic catalyst and reaction accelerator (a-4), like dimethylcyclohexylamine, dimethylbenzylamine, pentamethyldiethylentriamine or 2.dimethylaminoethyl ether;
metallic catalyst (a-5): tin octoate or dibutyltin dilaurate;
mass/volume stabilizer (a-6), like vegetable wax or paraffinic oil for controlling moulded product D shrinkage;
cream stabilizing agent (a-7): PMDS Polydimethylsiloxane for controlling the time for which the polymer C remains in the cream phase before expanding in the foam phase;
expanding agent (α-1): in particular methyl formate (with low toxic grade in comparison with other expanding agents);
chain extensor agent (α-2) selected between 3-Aminomethyl-3,5,5-trimethylcyclohexylamine and monoethylene glycol;
hydrophobic agent (α-3), like amorphous synthetic silica superficially treated with polyalkylsiloxane;
polymer MDI (b-1) derived from 4.4 diphenylmethane diisocyanate, 2.4 diphenylmethane diisocyanate, 2.2 diphenylmethane diisocyanate, with average functionality between 2.5 and 3;
polymer TDI (b-2): 2,4 toluene diisocyanate;
flow agent (b-3), like turpentine.

### Performance of the Manufactured Product (D)

The capillary hydrophobic polymer (C) may be moulded in various forms and/or machined to create new manufactured products (D), whose shapes are already known, such as floating booms, carpets, floccules, pillows, powders, sheets, rolls, pellets, cords, bands, bags, sacks, etc.

Said manufactured products have very interesting performance, as illustrated below.

The absorbent and adsorbent capacity of the manufactured products (D) disclosed is between 3 and 6 times greater, in terms of volume of oily pollutant, than the absorbent and adsorbent capacity of existing commercial products which are polyester-, polystyrene fibre- and polypropylene-based, and is between 6 and 10 times greater than natural products such as straw, sand, sawdust, vermiculite, peat, corn stalks, feathers, glass wool, volcanic ash, which are amongst those well-known in the prior art.

Said performance is due to the larger size of the cells (approximately 6 times the starting diameter of the polymer), as shown by the low specific weight of the manufactured product (between 80 and 150 grams per litre), and is also due to the higher number of re-use cycles of the manufactured product.

After each cycle of use of said manufactured product, it is wrung out to recover the oils adsorbed and absorbed, allowing a further re-use cycle.

The initial re-use efficiency is equal to 95% with a gradually decreasing rate. It is possible to reach between 10 and 20 re-use cycles, for heavy oil and light oil respectively.

The high and stable level of hydrophobic performance prevents any loss of the capacity to float of the manufactured product (D) during containing and recovering operations after spills of oil and its derivatives in the sea or in water.

The composition also allows an increase in the speed of absorption of high viscosity pollutant (30%) compared with existing products.

At the end of its useful life, the manufactured product may be used as a fuel due to its high energy content. It may also be disposed of in landfill, since it is biodegradable.

The manufactured products moulded in the form of booms are the ideal solution for containing large spills, on land or in water.

When quickly deployed, they contain spills of oil and chemical substances, preventing pollution of the environment and stopping said pollutants from entering our water supply and drainage systems.

Other forms, such as carpets, floccules, pillows, powder, foils, rolls, sheets, pellets, cords, bands and bags are more suitable for industrial and domestic spills.

Another interesting and effective application is use of the manufactured product as a filter for oily pollutant substances leaked in water.

The pollutant is retained by the manufactured product and the water, cleaned in that way, is available at the outfeed of the filter.

1. Adsorbent and absorbent capillary hydrophobic polymer (C), able to contain and remove oil, hydrocarbons and chemical products of non-aqueous matrix in the event of spills or leaks of the same inside or outside of the water, derived from a first component (A) comprising natural oily substances and a second component (B) comprising synthetic oily substances, said polymer (C) wherein the first component (A) is obtained from a mix of two agents (a-0, α-o), respectively obtained from a mix of sub-components (a-1-a-7, α-1-α-3), the first agent (a-0) being obtained from a mix of first sub-components (a-1-a-7):
vegetable oil (a-1) containing triglycerides and fatty acids with high molecular weight including OH groups; like 12-hydroxil-9 octadecenoic acid;
deionized water (a-2);
low grade (from 2 to 6 moles) ethoxylation surfactant (a-3), like nonylphenol ethoxylate, ethanol 2.2 dodecyloxy ethoxy and their mixture;
aminic catalyst and reaction accelerator (a-4), like dimethylcyclohexylamine, dimethylbenzylamine, pentamethyldiethylentriamine or 2.dimethylaminoethyl ether;
metallic catalyst (a-5): tin octoate or dibutyltin dilaurate;
mass/volume stabilizer (a-6), like vegetable wax or paraffinic oil;
cream stabilizing agent (a-7): PDMS Polydimethylsiloxane;
the second agent (α-0) being obtained from a mix of second sub-components (α-1-α-3);
expanding agent (α-1): in particular methyl formate (with low toxic grade in comparison with other expanding agents);
chain extensor agent (α-2) selected between 3-Aminomethyl-3,5,5-trimethylcyclohexylamine and monoethylene glycol;
hydrophobic agent (α-3), like amorphous synthetic silica superficially treated with polyalkylsiloxane;
and wherein the second component (B) is obtained from a mix/mixture of third sub-components (b-1-b-3):
polymer MDI (b-1) derived from 4.4 diphenylmethane diisocyanate, 2.4 diphenylmethane diisocyanate, 2.2 diphenylmethane diisocyanate, with average functionality between 2.5 and 3;
polymer TDI (b-2): 2,4 toluene diisocyanate;
flow agent (b-3), like turpentine.

2. The polymer (C) according to claim 1, wherein the first component (A) is obtained from a mix of the sub-components (a-1-a-7, α-1-α-3), with the following weight percentage of the different ingredients:
70-90% vegetable oil (a-1) containing triglycerides and fatty acids;
2.0-5% de-ionized water (a-2);
0.1-1.5% low grade ethoxylation surfactant (a-3);
0.0-0.5% aminic catalyst and reaction accelerator (a-4);
0.2-1.5% metallic catalyst (a-5);
0.2-1.5% mass/volume stabilizer (a-6), like vegetable wax or paraffinic oil;
1.0-5% cream stabilizing agent (a-7) PDMS Polydimethylsiloxane;
1.0-6.5% expanding agent (α-1);
2.0-6.0% chain extensor agent (α-2);
0.5-2.5% hydrophobic agent (α-3).
and wherein the second component (B) is obtained from a mix/mixture of the sub-components (b-1-b-3), with the following weight percentage of the different ingredients:
57-97% polymer MDI (b-1);
0.0-43% polymer TDI (b-2);
3.0-7.5% flow agent (b-3).

3. Polymer (C) wherein it is obtained from a mix of the first component (A) and the second component (B), in the following weight percentage:
47-53% of the first component (A);
53-47% of the second component (B).

4. The polymer (C) according to claim 1, wherein the vegetable oil (a-1) is derived from plant seeds and fruits of a wide range of species without any limitation, provided that they contain in their composition triglycerides and fatty acid with high molecular weight including OH groups, like palms, coconuts, sunflowers, castor beans, linseed, passion fruit, rapeseed.

5. A process to obtain the capillary hydrophobic polymer (C), adsorbent and absorbent, characterized by a first phase, necessary to obtain a first component (A), and by a second phase, necessary to obtain a second component (B), and by a third final phase, necessary to obtain the capillary hydrophobic polymer (C) with high adsorbent and absorbent power;
said first phase of the process, necessary to obtain the first component (A), comprising the following steps:
in a first container (E17) rotating at 1350 (±20%) RPM, all the sub-components (a-1), (a-2), (a-3), (a-4), (a-5), (a-6) and (a-7) are mixed for 20-30 minutes in order to obtain a first agent (a-0); according to the invention, the first container (E17) may also be a mixer;
in a second container (E20) rotating at 1400-1700 RPM, all the sub components (α1), (α-2), (α-3), are mixed for 10-15 minutes in order to obtain the second agent (α-0);
in a third container (E-24), rotating at 1/4-1/3 RPM, the mentioned first agent and second agent (α-0,a-0) are mixed for 20-25 minutes in order to obtain the first component (A); it is also possible to put the content of the second container (E20) inside the first container (E17) and vice versa, lowering the rotation speed to 1/4-1/3 RPM;
said second phase of the process, necessary in order to obtain the second component (B), comprising the following steps:
in a fourth container (E-36), hermetically closed and isolated from the external atmosphere, rotating at 1/4-1/3 RPM, all the sub-components (b1), (b-2), (b-3) are mixed for 20-30 minutes in order to obtain the second component (B);
said third final phase of the process, necessary in order to obtain the capillary hydrophobic polymer (C) with high adsorbent and absorbent power, comprising the following steps:
substantially equal quantities (47-53%) of the first component (A) and of the second component (B), obtained from the previous phases, are separately conveyed into the injection chamber of an injection machine (E-14) wherein the two components (A; B), in percentage weight between 47% and 53% are mixed to produce the polymer (C).

6. The process, according to claim 5, wherein the containers (E-17, E-20, E-24, E-36) may be completely or partly replaced with mixers.

7. The process, according to claim 5, wherein the capillary hydrophobic polymer (C) leaves the injection chamber of an injection machine (E-14) through the exit nozzle of said injection chamber (as a cream), to feed the mould connected to said nozzle and start the expansion process together with the forming process, in order to give the final commercial shape to the resulting final manufactured product (D); within 20-120 minutes (depending on the mould volume), said manufactured product (D) solidifies, reaching the final mechanical proprieties, being subsequently extracted from the mould.

8. Manufactured products (D) wherein they are constituted of the polymer (C) as per claim 1.

9. Manufactured products (D) as per claim 8, wherein they are moulded and/or machined in the form of booms, carpets, floccules, pillows, powder, foils, rolls, sheets, pellets, cords, bands and bags.

10. Filters and filtering systems wherein they utilize the manufactured product (D) as per claim 8.

11. Containing, removing and recovery methods for industrial, commercial and domestic spills and leaks of oil, hydrocarbons and chemical products of non-aqueous matrix characterized in that they utilize the manufactured products (D) as per claim 8.
